(19) United States
(12) Patent Application Publication
(10) Pub. No.: US 2025/0017266 A1
(43) Pub. Date: Jan. 16, 2025

(54) A Protective Member for an Aerosol Generating System

(71) Applicant: JT International S. A., Geneva (CH)

(72) Inventors: Layth Sliman Bouchuiguir, Bellevue (CH); Pier Paolo Monticone, Le Grand-Saconnex (CH)

(73) Assignee: JT International S.A., Geneva (CH)

(21) Appl. No.: 18/714,900

(22) PCT Filed: Nov. 29, 2022
(86) PCT No.: PCT/EP2022/083666

§ 371 Date: May 30, 2024

(30) Foreign Application Priority Data
Dec. 1, 2021 (EP) 21211726.1

(51) Int. Cl. A24F 40/40; A24F 40/95; H02J 7/00

(52) U.S. Cl. CPC A24F 40/40; A24F 40/95; H02J 7/0029

(57) ABSTRACT

An aerosol generating system includes an electronic cigarette with a vaping function and a protective member detachably mounted on the electronic cigarette. The electronic cigarette includes a first electrical connector.

The protective member includes a second electrical connector complementary to the first electrical connector and adapted to be coupled to the first electrical connector when the protective element is mounted on the electronic cigarette.

### FIELD OF THE INVENTION

The present invention relates to a protective member for an aerosol generating system and an aerosol generating system comprising such a protective member.

### BACKGROUND OF THE INVENTION

Aerosol generating systems enable vaporization of a product, generally by heating.

Known aerosol generating systems comprise an electronic cigarette on which is mounted a protective member of the cover type, which usually has thermal insulation properties. The electronic cigarette and the protective member form a mobile system to protect the user from burns during use.

For this purpose, the electronic cigarette and the protective member are provided with magnets so that the protective member is held in position on the electronic cigarette by the attractive force of the magnets. In some cases, the electronic cigarette includes a Hall effect sensor to detect the presence of the protective member.

There is a need to improve the safety of such aerosol generating systems, particularly when used by a user.

### SUMMARY OF THE INVENTION

The present invention thus relates to an aerosol generating system comprising an electronic cigarette with a vaping function and a protective member of the cover type detachably mounted on the electronic cigarette, said electronic cigarette comprising a first electrical connector, said aerosol generating system being characterized in that said protective member comprises a second electrical connector complementary to the first electrical connector and configured to be electrically coupled by mechanical engagement to the first electrical connector when the protective member is mounted on the electronic cigarette.

Maintaining the protective member on the electronic cigarette is very important as it improves the safety of the aerosol generation system. This is because the electronic cigarette can heat up during its use or its charge and the protective member provides a thermal protection function. In particular the protecting member of the cover type allows to avoid a user being burned during use, i.e. while handling the aerosol generating system. In other words, the protective member of the cover type acts as a thermal insulator on the electronic cigarette, especially when it is used.

The cooperation of the first electrical connector and the second electrical connector thus makes it possible to provide a safer aerosol generation system by improving the retention of the protective member on the electronic cigarette, while maintaining detachability. The cooperation between the first electrical connector and the second electrical connector results both from mechanical coupling by mechanical engagement and also electrical coupling by electrical contact. The mechanical engagement is configured to hold the protective element is position on the electronic cigarette. In other words, this cooperation provides both an electrical connection and a mechanical hold between the electronic cigarette and the protective member.

By mechanical engagement is meant an assembly of two parts implementing a mechanical interlocking when these parts are assembled. In the context of the present invention, the mechanical engagement of the first electrical connector and the second electrical connector is removable provided that sufficient force is applied to mechanically unlock them. In addition, it is no longer necessary to add additional members, such as magnets, to ensure the retention between the protective member and the electronic cigarette. Indeed, most, if not all, electronic cigarettes include an electrical connector generally intended for charging. Thus, the aerosol generating system according to the invention makes it possible to mount the protective member without modifying the electronic cigarette. This is particularly advantageous for reducing the weight of such a system or avoiding the introduction of members that could disturb the system or its environment.

Furthermore, dust typically infiltrates the first electrical connector, due to the place where electronic cigarettes are stored, for example in a trouser pocket. The protective members of the prior art do not dust from getting in, especially when dust is trapped between the protective member and the electronic cigarette. The protective member according to the invention makes it possible to prevent the first electrical connector from clogging by coupling, in particular mechanical coupling, with the second electrical connector.

Preferably, the protective member comprises an integrated circuit connected electrically to the second electrical connector and said electronic cigarette comprises a controller connected electrically to the first electrical connector, said integrated circuit being configured to send a signal to the controller when the first electrical connector is coupled to the second electrical connector.

The electrical coupling between the first electrical connector and the second electrical connector makes it possible to transfer the signal emitted by the integrated circuit of the protective member to the controller of the electronic cigarette. It is therefore possible for the controller to detect the presence of the protective member. The detection of the protective member is then only possible if the electrical connectors are coupled, in particular electrically coupled, contrary to the systems of the prior art in which a magnet enables the detection of the protective member. As the electrical coupling of the electrical connectors requires sufficient mechanical engagement between the electrical connectors, the detection of the protective member requires the correct positioning and mounting of the latter on the electronic cigarette. It is thus possible to detect the presence of the protective member and thus to detect whether it is correctly positioned on the electronic cigarette.

In a preferred embodiment, the controller is configured to disable the vaping function of the electronic cigarette until reception of said signal.

In other words, the controller authorizes the vaping function when it receives the signal from the integrated circuit. It is therefore not possible to use the electronic cigarette for vaping without the protective member being detected, i.e. correctly positioned. Thus, it is also not possible to use the electronic cigarette when charging, provided that the charging signal differs from the signal emitted by the integrated circuit. Thus, the controller can be configured to differentiate the signal emitted by the integrated circuit from the charging signal.

Preferably, the signal comprises a second unique code, said controller being configured to compare said second unique code to a first unique code stored in a memory of said electronic cigarette.

During manufacturing for example, each electronic cigarette may be associated with a protective member by a unique code. When the first electrical connector is coupled to the second electrical connector, the signal containing the second unique code is sent to the controller which compares it with the first unique code. Thus, it is possible to verify the authenticity of the protective member. This can be particularly useful when there are protective members on the market, sometimes customizable, which are not approved by the manufacturer of the aerosol generating system. Such protective members usually do not have a sufficient level of protection and can therefore put a user at risk.

In case of loss, theft or breakage of the protective member, the electronic cigarette can be repaired, preferably by the manufacturer or a certified person, to be associated with a new protective member.

Advantageously, the electronic cigarette has a first surface adjacent to said first electrical connector, said first surface being provided with at least one protruding or recessed portion, said protective member having a second surface adjacent to said second electrical connector which is provided with at least one complementary portion so as to provide mechanical engagement with said at least one protruding or recessed portion when the protective member is mounted on said electronic cigarette.

The mechanical engagement between the at least one protruding or recessed portion and the at least one complementary portion further improves the fit of the protective member on the electronic cigarette. The risk of dropping and then losing the protective member is thus reduced.

Furthermore, the mechanical engagement obtained by the coupling of the electrical connectors and the mechanical engagement obtained by protruding or recessed portions form at least two distinct fastening points between the electronic cigarette and the protective member. This has the effect of reducing, or even eliminating, the torsional forces that can be applied to the electrical connectors when the protective member is mounted on the electronic cigarette.

In addition, these portions enable one of the first electrical connector or the second electrical connector to be aligned with the other and to guide the protective member in translation when it is mounted on the electronic cigarette. Thus, the cooperation between the at least one protruding or recessed portion and the at least one complementary portion makes it possible to protect the electrical connectors and more particularly the electrical contacts that they comprise. These portions can also act as foolproof devices, which is particularly useful if the mounting of the protective member is not obvious and/or if the electrical connectors require a particular assembly direction.

Preferably, the first electrical connector and the second electrical connector are USB type C connectors.

USB Type C connectors have the advantage that they are reversible, i.e. they can be connected in either direction. This is particularly advantageous if the protective member can also be mounted in either direction. This is because the user can easily and quickly mount the protective member on the electronic cigarette.

In addition, the known performance and capabilities of USB Type C connectors, such as the transfer of audio and video signals or the increase in transfer speed, enables for new functionalities of the protective member.

Advantageously, the protective member comprises a battery which is electrically connected to the second electrical connector.

The battery of the protective member makes it possible to charge the electronic cigarette with electrical energy when the electrical connectors are coupled. Electrical energy thus flows from the protective member to the electronic cigarette through the first and second electrical connectors. The battery of the protective member acts as an additional energy source for charging or recharging the electronic cigarette. Thanks to this, it is possible to charge the electronic cigarette without having to remove the protective member. This is particularly advantageous when the electronic cigarette only enables vaping function in the presence of the protective member.

Preferably, the protective member comprises a charging coil that generates an electric current under the action of an electromagnetic field, said charging coil being electrically connected to the second electrical connector.

The electric current generated by the charging coil is transmitted to the second electrical connector. When the second electrical connector is coupled to the first electrical connector, the electrical current enables the electronic cigarette to be charged, and more specifically to charge a battery of the electronic cigarette. Thus, it is possible to charge or recharge the electronic cigarette without disassembling the protective member.

If the protective member comprises a battery, the charging coil can be connected to the battery so that the electric current directly charges the battery.

Advantageously, the protective member further comprises a communication module which is electrically connected to the second electrical connector.

When the second electrical connector is coupled to the first electrical connector, the communication module can exchange data with the electronic cigarette. In addition the communication module can be powered by the electronic cigarette when the first and second electrical connectors are coupled. Thanks to the communication module, it is possible to establish a connection, preferably wireless, with devices external to the aerosol generation system, such as smartphones or other aerosol generation systems. This makes it possible, for example, to display on an external device information related to the electronic cigarette, such as the battery charge level, the aerosol generating substrate level, statistics about the use, or the location. The communication module can be implemented using any suitable technology, for example Wi-Fi, Bluetooth, GSM, 3G, 4G, 5G and the like.

According to another aspect, the present invention relates to a protective member for an aerosol generating system as recited above, characterized in that it comprises a second electrical connector configured to be coupled to a first electrical connector of an electronic cigarette.

The protective member presents the same advantages as the ones described in relation with the aerosol generating system.

Preferably, the protective member comprises an integrated circuit which is connected electrically to the second electrical connector.

Preferably again, the protective member has a second surface adjacent to said second electrical connector, said second surface being provided with at least one protruding or recessed portion.

Advantageously, the protective member comprises a battery which is electrically connected to the second electrical connector.

Preferably, the protective member comprises a charging coil configured to generate an electric current under the action of an electromagnetic field.

Preferably at last, the protective member comprises a communication module which is electrically connected to the second electrical connector.

### BRIEF DESCRIPTION OF THE DRAWINGS

Other particularities and advantages of the invention will also emerge from the following description.

In the accompanying drawings, given by way of non-limiting examples:

FIG. 1 represents, in a schematic view, an aerosol generating system comprising an electronic cigarette and a protective element according to one embodiment of the invention, the protective element being separated from the electronic cigarette; and

FIG. 2 is a view similar to FIG. 1, in which the protective element is mounted on the electronic cigarette.

### DETAILED DESCRIPTION

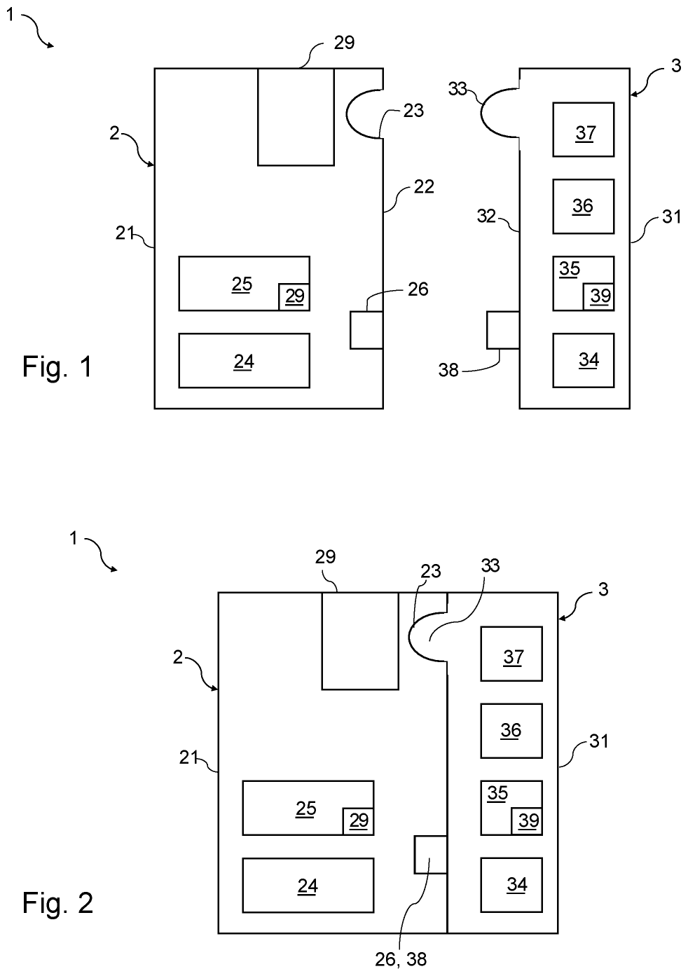

FIG. 1 represents an aerosol generating system 1 according to an embodiment. The aerosol generating system 1 comprises an electronic cigarette 2 and a protective element 3, which is detachably mountable on the electronic cigarette.

The electronic cigarette 2 comprises a housing 21 having a substantially cuboid shape. As illustrated, the housing 21 has a substantially rectangular parallelepiped shape. However, edges and corners of the housing 21 may be rounded in order to be more pleasant for a user. In the embodiment illustrated in FIGS. 1 and 2, the electronic cigarette 2 is of the heat-not-burn type. As such, the housing 21 defines a cavity 29 adapted to receive an aerosol forming substrate. However, the invention is not limited to this type of electronic cigarette and can be implemented with any type of electronic cigarette.

The electronic cigarette 2 includes heaters not shown and arranged around the cavity 29. The heaters are used to heat the interior of the cavity 29 for heating an aerosol forming substrate to be inserted into the cavity. The cavity 29 and thus the heaters are located near a first surface 22 of the housing 21. The first surface 22 is then likely to heat more than the other surfaces of the housing 21. The first surface 22 is here relatively flat and extends between a top surface at which the cavity 29 is open and a bottom surface opposite the top surface.

The housing 21 has a first portion 23 recessed inwardly of the housing from the first surface 22. The first recessed portion 23 here has a rounded shape.

The electronic cigarette 2 comprises a battery 24 and a controller 25 provided inside the housing 21. The battery 24 is electrically connected to the heaters as well as to the controller 25 by conducting wires. The controller 25 is also connected to the heaters to control them. The controller 25 has a memory 29 in which a first unique code is stored.

The electronic cigarette 2 also includes a first electrical connector 26 electrically connected to the battery 24 by conducting wires. In the present embodiment, the first electrical connector 26 is of the female type. The first electrical connector 26 extends inside the housing 21 and is open at the first surface 22. In particular, the first electrical connector 26 allows a charging cable equipped with a complementary electrical connector to be connected to charge the battery 24.

The protective member 3 is of the cover type. It forms, with the electronic cigarette 2, a mobile assembly that can be handled, i.e handlable, by a user. The protective member 3 is intended to be mounted on the electronic cigarette 2 especially when the electronic cigarette is used by the user. Of course, it can also be mounted at any other time.

The protective member 3 comprises a housing 31 whose dimensions are substantially smaller than those of the housing 21 of the electronic cigarette 2. The housing 31 of the protective member 3 has thermal insulation properties. In particular, this housing 31 can be made from materials with low thermal conductivity such as thermoplastics and engineering plastics.

The housing 31 of the protective member 3 has a second surface 32 complementary in shape to the first surface 22. This housing 31 has a second portion 33 protruding outwardly of the second surface 32 from the housing. The second protruding portion 33 here has a rounded shape. The second protruding portion 33 extends to a length greater than the length from which the second electrical connector 38 projects from the second surface 32. In this manner, the second protruding portion 33 contacts the housing 21 of the electronic cigarette 2 before the second electrical connector 38, when mounting the protective member 3 on the electronic cigarette, as described below.

Here, the protective member 3 includes a battery 34, an integrated circuit 35, a charging coil 36, a communication module 37 and a second electrical connector 38.

The second electrical connector 38 is electrically connected to the battery 34, the integrated circuit 35, the charging coil 36, and the communication module 37, via conducting wires not shown.

The second electrical connector 38 is of the male type. The second electrical connector 38 extends outwardly from the housing 31 from the second surface 32. The second electrical connector 38 is complementary to the first electrical connector 26.

In the illustrated embodiment, the battery 34 of the protective member 3 is electrically connected to the integrated circuit 35 and the communication module 37 to provide electrical power thereto. The integrated circuit 35 can be supplied with energy by the battery 24 of the electronic cigarette 2 via the coupling of the electrical connectors 26 and 38. In this case, the integrated circuit 35 can be configured to emit a signal as soon as it is supplied with energy.

The communication module 37 may be a Wi-Fi, Bluetooth, GSM, 3G, 4G, 5G or other wireless module.

The battery 34 is electrically connected to the charging coil 36 so that when the charging coil is subjected to an electric field, the charging coil generates an electric current that recharges the battery.

The integrated circuit 35 can include or can be connected to a memory 39 in which a second unique code is stored. The integrated circuit 35 is configured to send a signal including the second unique code to the second electrical connector 38.

As shown in FIG. 2, the protective member 3 is mounted on the electronic cigarette 2. To accomplish this mounting, the first recessed portion 23 fits into the second protruding portion 33 to align the first and second electrical connectors 26 and 38. Then the second electrical connector 38 fits into the first electrical connector 26 so that they are coupled both mechanically and electrically. In particular, the second electrical connector 38 is inserted into the first electrical connector 26 so that the protective member 3 is held in position on the electronic cigarette 2.

The assembly is removable. The protective member 3 can, for example, be removed to release the first electrical connector 26 of the electronic cigarette 2 in order to recharge it with a wired charger or a fixed charging station.

A force greater than the weight of the electronic cigarette 2 is preferably required to separate the protective element 3 from the electronic cigarette 2. This prevents the electronic cigarette 2 from coming off the protective member 3 when the user handles the aerosol generating system 1 by holding it only by the protective member 3, and vice versa. Once assembled, the housing 21 of the electronic cigarette 2 and the housing 31 of the protective member 3 define a substantially homogeneous shape, i.e. without discontinuities.

When the electrical connectors 26 and 38 are electrically coupled, the integrated circuit 35 sends the signal including the second unique code stored in its memory 39 to the controller 25. The controller 25 then checks whether the first unique code stored in its memory 29 matches the second unique code.

If the first unique code matches the second unique code, the controller 25 enables the vaping function of the electronic cigarette 2 and the heaters can be activated by the user, for example. If the first unique code does not match the second unique code, the controller 25 disables the vaping function of the electronic cigarette 2 and the heaters cannot be activated despite the action of the user. In other words, the controller 25 can be configured to disable the vaping function if the authenticity of the protective member 3 is not recognized, i.e. the second unique code does not match the first unique code. Conversely, the controller 25 can be configured to enable the vaping function can be enabled if the authenticity of the protective member 3 is recognized, i.e. the second unique code matches the first unique code.

In addition to its function of supplying electrical energy to the various components of the protective member 3, the battery 34 can also recharge the battery 24 of the electronic cigarette 2 by transmitting electrical energy through the first and second electrical connectors 26 and 38. The same applies to the charging coil 36, which, in addition to sending the electrical current to the battery 34 of the protective element 3, can also send this electrical current to the battery 24 of the electronic cigarette 2.

The communication module 37 enables signals or information to be received and/or transmitted from and/or to devices external to the aerosol generating system 1. Information relating to the electronic cigarette 2 may be emitted, for example by the controller 25, and transmitted via the first and second electrical connectors 26 and 38 to the communication module 37. This information may subsequently be transmitted to the external devices.

Alternatives not shown are described below.

Other forms of housing can be considered, for example the housing of the electronic cigarette and/or the housing of the protective element may have a shape of an elongated cylinder, like a pen.

The housing of the electronic cigarette and that of the protective element may respectively comprise several protruding or recessed portions. Other shapes of protruding or recessed portions can be envisaged, such as elongated, polygonal or a combination of these shapes. In particular, the recessed portion of the electronic cigarette may instead protrude, i.e., project outwardly from the housing from the first surface while the protruding member of the protective element may instead be recessed.

The first electrical connector may be male and the second electrical connector may be female.

It is possible for the electronic cigarette not to comprise a cavity and/or heaters and/or battery and/or controller.

It is also possible for the protective element not to comprise a battery and/or integrated circuit and/or charging coil and/or a communication module.

Finally, the invention is not limited to a particular type of electrical connector and any type of electrical connector may be contemplated, for example USB connectors of type A, B or C.

1. An aerosol generating system comprising:
an electronic cigarette with a vaping function; and
a protective member of the cover type detachably mounted on the electronic cigarette,
said electronic cigarette comprising a first electrical connector and said protective member comprising a second electrical connector, wherein the second electrical connector of the protective member is complementary to the first electrical connector and configured to be electrically coupled by mechanical engagement to the first electrical connector when the protective member is mounted on the electronic cigarette.

2. The aerosol generating system according to claim 1, wherein said protective member comprises an integrated circuit connected electrically to the second electrical connector and said electronic cigarette comprises a controller connected electrically to the first electrical connector, said integrated circuit configured to send a signal to the controller when the first electrical connector is coupled to the second electrical connector.

3. The aerosol generating system according to claim 2, wherein said controller is configured to disable the vaping function of the electronic cigarette until reception of said signal.

4. The aerosol generating system according to claim 2, wherein said electronic cigarette comprises a memory,
wherein a first unique code is stored in said memory, and
wherein said signal comprises a second unique code, said controller configured to compare said second unique code to the first unique code.

5. The aerosol generating system according to claim 1, wherein said electronic cigarette has a first surface adjacent to said first electrical connector, said first surface provided with at least one protruding or recessed portion, said protective member having a second surface adjacent to said second electrical connector provided with at least one complementary portion so as to provide mechanical engagement with said at least one protruding or recessed portion when the protective member is mounted on said electronic cigarette.

6. The aerosol generating system according to claim 1, wherein said first electrical connector and said second electrical connector are USB type C connectors.

7. The aerosol generating system according to claim 1, wherein said protective member comprises a battery electrically connected to the second electrical connector.

8. The aerosol generating system according to claim 1, wherein said protective member further comprises a charging coil configured to generate an electric current under the action of an electromagnetic field, said charging coil being electrically connected to the second electrical connector.

9. The aerosol generating system according to claim 1, wherein said protective member further comprises a communication module electrically connected to the second electrical connector.

10. A protective member for an aerosol generating system according to claim 1, wherein said protective member comprises the second electrical connector configured to be coupled to the first electrical connector of an electronic cigarette.

11. The protective member according to claim 10, further comprising an integrated circuit connected electrically to the second electrical connector.

12. The protective member according to claim 10, further comprising a second surface adjacent to said second electrical connector, said second surface provided with at least one protruding or recessed portion.

13. The protective member according to claim 10, further comprising a battery electrically connected to the second electrical connector.

14. The protective member according to claim 10, further comprising a charging coil configured to generate an electric current under the action of an electromagnetic field.

15. The protective member according to claim 10, further comprising a communication module electrically connected to the second electrical connector.
